(19) United States
(12) Patent Application Publication
(10) Pub. No.: US 2011/0173763 A1
(43) Pub. Date: Jul. 21, 2011

(54) MODIFIED CELLULOSIC MATERIALS

(76) Inventors: Colin Robert Willis, Salisbury (GB); Stuart Anson Brewer, Salisbury (GB); John Anthony Taylor, Manchester (GB); Duncan Adrian Phillips, Lancashire (GB)

(21) Appl. No.: 12/863,205

(22) PCT Filed: Jan. 26, 2009
(86) PCT No.: PCT/GB2009/000196

§ 371 Date: Apr. 6, 2011

(30) Foreign Application Priority Data
Jan. 25, 2008 (GB) 0801346.8

(51) Int. Cl. C09B 62/04; C08B 15/06; C08L 1/08; C09B 62/00; D06M 23/00

(52) U.S. Cl. 8/549; 536/31; 524/31; 536/43; 8/543; 8/116.1

(57) ABSTRACT

The invention provides a process for aminoarylating cellulosic materials such as cotton and reconstituted fibres and a process for treating the aminoarylated cellulose with an effect chemical such as a dye, flame retardant or cross linking agent. Improved take up of the effect chemical by the modified cellulose means increased efficiency in the process and in the case of dyeing, avoids or reduces the washing off of hydrolysed dye and the resultant production of large volumes of contaminated water requiring to be treated. The cellulosic material may be present in a blend with other types of fibre for example a blend with poly(alkyleneterephthalates) or polyamides.

The present invention relates to a novel method for pre-treating cellulose-containing materials to improve their take up of effect chemicals such as reactive dyes, cross linking agents and flame retardants. In particular it is concerned with modification by the introduction into the cellulosic material of an aminoaryl function.

Reactive dyes derive their name from the fact that they react chemically with cellulose to form a covalent bond which cannot readily be broken and thus imparts very high wet fastness to the dyed fabric or fibre. The formation of such a covalent bond relies on the reaction of a nucleophilic alcohol group present in the cellulose with an electrophilic group present in the dye molecule. In the case of reactive dyes the electrophilic group is usually a haloheterocycle, such as chlorotriazine, or a Michael type acceptor such as a vinyl sulphone.

There are several drawbacks associated with the usage of such materials as dyes for cellulosic substrates. Reactive dyes are invariably applied in the presence of water and alkali, the alkali being present in order to generate cellulosate anion, the active nucleophile that reacts with the dye. Unfortunately the high pH and consequential high concentration of hydroxide ion causes a competing, undesired, hydrolysis as an appreciable side reaction. This is particularly problematical at heavy depths of shade, not only because of the wastage of dye, per se, but more importantly because of the large quantities of hydrolysed dye that need to be removed from the fibre to ensure satisfactory fastness. Removal of hydrolysed dye, which can typically comprise 10 to 30% of that applied, is accomplished by a lengthy wash off sequence with consequential production of large volumes of coloured effluent. Stringent environmental regulations increasingly demand that this colour be discharged: reactive dye residues are usually particularly difficult, and therefore expensive, to remove from dilute aqueous solution.

Consequently the use of reactive dyes involves a substantial wastage and extensive and costly clean up of aqueous by-products.

Cross linking reagents, which are often applied to confer crease resistance to cellulose fabrics, are usually applied under conditions of high acidity and temperature which can cause severe tendering of cotton.

Traditionally the manufacturers of dyes and other effect chemicals have sought to minimize the undesired hydrolysis by a combination of physical and chemical methods. Thus, in reactive exhaust dyeing, dyes are delivered physically to the cellulose by ‘salting on’. Additionally, dye manufacturers have incorporated two or more electrophilic reactive groups within a dye molecule as a route to higher fixation. These reactive groups may be similar, as in Procion XL+ dyes, or dissimilar.

To date, however, no practical method has been developed to achieve quantitative covalent fixation of effect chemicals, such as dyes, to cellulosic substrates. Such a method would have major potential commercial and technical advantages. Complete utilisation of dye would, in itself, represent a considerable economic advance over currently available technology. As well as requiring less dye for a given depth of shade, several other important economic and environmental advantages accrue, including the avoidance of unfixed colour and of coloured effluent, hence the potential to re-cycle dyebath liquors, leading to very considerable savings in the consumption of both energy and water.

For example, on the basis that some 15 million tonnes of cellulosic fibres are coloured with reactive dyes each year and that each tonne of fibre/fabric requires of the order of 50 tonnes of water to complete the dyeing and (mainly) wash off sequences, this equates to an overall usage of the order of 750 million tonnes of water per annum. This requirement is particularly important when it is appreciated that the dyeing industry has now largely moved to Asia, often to areas with limited water resources.

It has been recognised that a possible solution to achieving the quantitative covalent fixation of effect chemicals involves the modification of the cellulose by attaching amino residues to the cellulosic fibres. This is on account of the enhanced nucleophilicity of the amino group in comparison to the hydroxyl group such that it is able to react with many electrophiles under essentially neutral conditions.

Various methods of aminating cellulose have been described. For example EP 0703305 (Schrell et al) describes a method for the preparation of regenerated cellulosic fibres, by making a solution of cellulose and high molecular weight protein and spinning fibres from the solution. Also described is a method of dyeing the resulting fibres with anionic dyes in absence of electrolyte: acid dyes at pH 4-6 and reactive dyes at pH 6-8.5.

The covalent attachment of amino residues to cellulosic fibres has been described in DE 4402210 (Schrell et al) which relates to a method for aminating cotton fibres by treating raw cotton at the boiling, scouring or dry mercerising stage with, for example, N-sulphatoethyl piperazine and dyeing the resulting fibre in absence of added electrolyte. However, sulphonic acid residues reduce the substantivity of the dye for the modified fibre as noted above.

Ho et al (J Korean Fibre Soc. 28 (1991) 583) describe the reaction of 4-aminophenyl-2-sulphatoethyl sulphone with cotton to produce a 4-aminophenylsulphonyl ethyl group attached to cotton. The present inventors have produced cotton with this residue attached but the amino group of the resulting modified cotton is insufficiently nucleophilic to react efficiently with (electrophilic) reactive dyes.

Recently methods of aminating cellulose have been reviewed by Xu, Renfrew and Phillips (Coloration Technology 2006 122, 37-44). All of the strategies reported in this paper suffer from one or other of the following drawbacks:
a) commercial unattractiveness due to a requirement to use non-aqueous processing conditions;
b) production of a hydrolytically unstable ester linkage between the amino residue and the cellulose, resulting in cleavage under normal dyeing and/or washing regimes with loss of colour from the cellulose;
c) production of a modified fibre which, when coloured with reactive dye, suffers from poor light fastness and/or poor levelling of dyeing e.g. alkyl aminocellulose;
d) production of an aminofuctionalised cellulose that also contains sulphonic acid residues that reduce the substantivity of the dye for the modified fibre.

It is an object of this invention to provide a material which overcomes or avoids these problems and to that end applicant has now devised a method for treating cellulose-based materials such as cotton with an effect chemical whereby there are introduced into such materials aminoaryl substituents which are stable and are capable of subsequent reaction with conventional electrophilic reactive groups, such as those found in conventional reactive dyes and other effect chemicals, under slightly acidic conditions (pH 4-5). By the term “effect chemical” used herein is meant a dye (particularly a reactive dye), a cross linking reagent, a flame retardant, a cyclodextrin or the like.

Suitably aminoarylated cellulosic materials have the advantage therefore of undergoing fixation under mildly acidic conditions, thus very greatly reducing the concentration of hydroxide ion present in the treatment (dyeing) process and hence the rate of competitive hydrolysis of the effect chemical, leading to essentially complete reaction of the latter with the fibre. The method has particularly advantageous application in the case of dyeing with reactive dyes for the reasons explained herein.

Accordingly the present invention provides a method for treating a cellulose-containing material with an effect chemical comprising the steps of:
a) effecting the aminoarylation of a cellulose-containing material to provide a substantially nucleophilic material; and
b) applying to the product of step (a) an effect chemical under acidic conditions.

By cellulose-containing or cellulosic material is herein meant a material which comprises cellulose, the cellulose typically being in the form of cotton or other cellulose-based fibres such as Ramie and hemp as well as reconstituted cellulosic fibres, e.g. viscose and lyocell. The cellulosic material may be present in a blend with other types of fibre for example a blend with poly(alkyleneterephthalates) and/or polyamides.

It should be understood that in any given sample of a cellulosic material that is to be treated with a dye or other effect chemical it is only necessary that a minor proportion of the hydroxyl groups attached to the cellulosic material should be reacted with the effect chemical since this is sufficient to impart the required properties to the cellulosic material. For example in the case where the effect chemical is a reactive dye, usually even the heaviest dyed shades require the addition to the material of no more than 10% by weight of dye. This equates to about 1 in 50 of the primary hydroxyl groups of the cellulose being substituted with dye molecule. Consequently it will be desirable that in substituting aminoaryl groups into the cellulosic starting material at least the same degree of substitution should be achieved at least in the case where the modified product is to be used for heavy shades. In practice it will be appropriate to achieve a higher degree of aminoaryl substitution on the cellulose primary hydroxyl groups than is required of the particular effect chemical treatment for which the cellulosic material is intended in order that the ease of subsequent reaction with the effect chemical is not prejudiced. Typically, therefore, it will be appropriate that between about 0.1 and 10% of the primary hydroxyl groups on the modified cellulose will be substituted with aminoaryl groups.

According to a second aspect the invention provides an aminoarylated cellulosic material having the formula:

Cell-O—X—(Y—Ar—NHR)ₙ (I)

where Cell-O— represents a substituted hydroxyl of a cellulosic material;
X is a bond or a group selected from the following:
2,4-triazinyl optionally substituted in the 6-position by a group selected from alkoxy, alkylthio, amino, alkylamino (optionally substituted), dialkylamino (optionally substituted), arylamino (optionally substituted) and alkylarylamino (optionally substituted); 2,4-pyrimidinyl or 2,6-pyrimidinyl, the pyrimidine nucleus optionally carrying substituents selected from chloro and fluoro; alkylene C₁₋₆; and alkoxy C₂₋₁₂;
Y is a linking group and is present when X is other than a bond;
Ar is an arylene group which may be substituted by one or more groups selected from alkyl, alkoxy, acylamino, alkylthio;
R is H or an alkyl group which may by substituted by a group selected from hydroxyl or alkoxy; and
n is either 1 or 2 except that when X is a bond, n=1.

Preferably the group X is a 2,4-triazinyl group.

Preferably the group Y is —NH— or —NR′ where R′ is alkyl optionally substituted by hydroxyl, alkoxy or halo.

Preferably Ar is a 1,3-phenylene or a 1,4-phenylene group which may be substituted as described.

Preferably the product of step (a) in the method for treating a cellulose-containing material with an effect chemical is a material according to formula (I).

Preferably the amino group in the aminoaryl substituent attached to the cellulosic material will be sufficiently nucleophilic to react with the electrophilic reactive group or groups of a dye or other effect chemical within the usual timescales of the reaction cycle (e.g. for a reactive dye of less than 4 hours at a typical dyeing temperature of from 60 to 80° C.). Thus the aryl group bearing the amino substituent should not itself be substituted with strongly electron-withdrawing groups such as nitro or cyano.

At the same time the aminoaryl substituent should not be anionic in character so as to minimise the electrostatic repulsion between aminoarylated fibre and the anionic reactive dye (or other reagent) and hence facilitate the approach of the dye to the fibre and give maximum fixation to the modified (aminoarylated) fibre. For example it is preferred that no groups such as sulphonate or carboxylate are present as substituents in the aryl ring.

Typically the attachment of an aminoaryl substituent to cellulose is achieved in two steps comprising firstly fixation to the cellulosic material of an electrophilic species possessing a masked amino group followed by regeneration of the free amino function.

Typical electrophilic groups suitable for the attachment of masked amines to cellulose include halo nitroaryl compounds and derived quaternary salts, as well as their heteroaryl analogues. Suitable masked amines include acylamino, acylalkylamino, nitro and azo derivatives, from which the desired amino functions can be readily obtained, the first two by alkaline hydrolysis and the last two by reduction.

Accordingly, in a third aspect, the present invention further provides a method for preparing the modified cellulosic material of the invention by reacting a cellulosic material with a reagent having the formula:

LG-X—(Y—Ar—Z)ₙ (II)

where LG is a leaving group selected from halo or a tertiary amine;
X is a bond or a group selected from the following:
2,4-triazinyl optionally substituted in the 6-position by a group selected from chloro, fluoro, alkoxy, alkylthio, amino, alkylamino (optionally substituted), dialkylamino (optionally substituted), acylamino (optionally substituted) and alkylarylamino (optionally substituted); 2,4-pyrimidinyl or 2,6-pyrimidinyl, the pyrimidine nucleus optionally carrying substituents selected from chloro and fluoro; alkylene C₁₋₆; and alkoxy C₂₋₁₂;
Y is a linking group and is present when X is other than a bond;
Ar is an arylene group which may be substituted by one or more groups selected from alkyl, alkoxy, acylamino, alkylthio;
Z is a precursor for an amino group such as nitro or acylamino or is a precursor for an alkylamino group such as acylalkylamino; and
n is either 1 or 2 except that when X is a bond, n=1;
other than that where X is 2,4-triazinyl substituted in the 6-position by chloro, Y is —NH—,
Ar is unsubstituted, Z is nitro and n=1, LG shall not be chloro; and subsequently converting the group Z to an amino group.

Preferably the group X is a 2,4-triazinyl group.

Preferably the group Y is —NH— or —NR′ where R′ is alkyl optionally substituted by hydroxyl, alkoxy or halo.

Preferably Ar is a 1,3-phenylene or a 1,4-phenylene group which may be substituted as described.

Preferably step (a) of the method for treating a cellulose-containing material with an effect chemical comprises the method for preparing the modified cellulosic material using reagent (II). In reagent (II), the leaving group is a group which is readily detached from the reagent under conditions appropriate to effecting the reaction with the cellulosic material and may be a halo group (such as F or Cl in particular) or a tertiary amine, particularly a heteroaryl tertiary amine such as pyridine or a substituted pyridine or a non-hindered tertiary aliphatic amine such as diazabicyclo octane (DABCO). The leaving group may be a pre-formed benzenoid quaternary ammonium salt, as in Scheme 1:

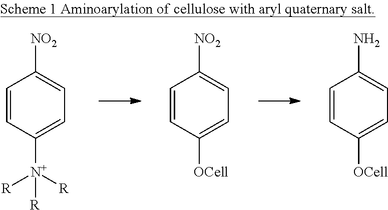

Alternatively (and preferably) heteroaryl quaternary salts (such as halotriazinyl or halopyrimidinyl quaternary salts) may be employed as shown in Scheme 2:

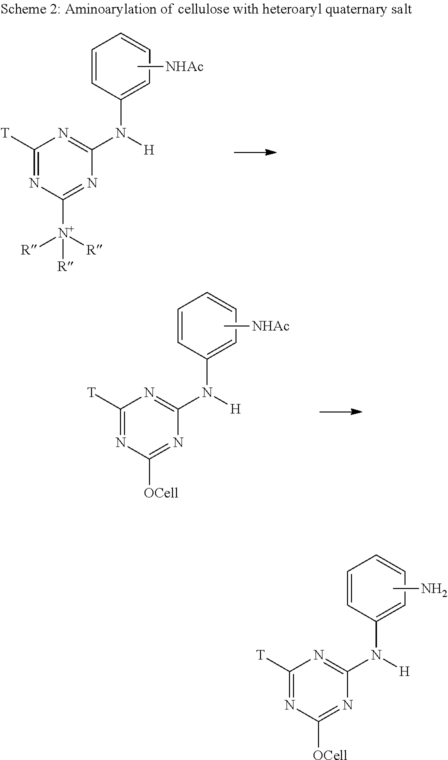

or as a further alternative to utilising pre-formed quaternary ammonium salts for the attachment of protected amino-aryl and -heteroarylgroups to the cellulose, the precursor halo-aryl and halo-heteroaryl compounds can be used in the presence of catalytic quantities of a tertiary amine, such as nicotinic acid. Under these application conditions the quaternary salt is formed in situ and then reacts with the cellulose. (Nicotinic acid is already employed in the Kayacelon React range of dye and is a (fairly) benign intermediate to discharge to drain). Importantly, whilst the chloro derivative requires dispersion in the aqueous media, the intermediate quaternary salts will possess some water solubility and will therefore be amenable to application from an aqueous environment.

The quaternary salts are also likely to be preferred because of their cationic nature and hence affinity for cellulose since cellulose tends to be anionic in character in view of the presence always of carboxylic acid groups thereon.

In the above Schemes 1 and 2, the leaving group R″₃N— may be an aliphatic tertiary amine such as trimethylamine or diazabicylooctane (DABCO), or a heterocyclic amine such as pyridine or a substituted pyridine such as 3- or 4-carboxypyridine or 3- or 4-carbonamido pyridine. Substituent T is one of the group selected from chloro, fluoro, alkoxy, alkylthio, amino, alkylamino (optionally substituted), dialkylamino (optionally substituted), arylamino (optionally substituted) and alkylarylamino (optionally substituted).

Generally therefore the preparation of the modified cellulosic material of the invention will proceed via an intermediate having the formula:

Cell-O—X—(Y—Ar—Z)ₙ (III)

where Cell-O— represents a substituted hydroxyl of a cellulosic material; X is a bond or a group selected from the following:
2,4-triazinyl optionally substituted in the 6-position by a group selected from alkoxy, alkylthio, amino, alkylamino (optionally substituted), dialkylamino (optionally substituted), arylamino (optionally substituted) and alkylarylamino (optionally substituted); 2,4-pyrimidinyl or 2,6-pyrimidinyl, the pyrimidine nucleus optionally carrying substituents selected from chloro and fluoro; alkylene C₁₋₆; and alkoxy C₂₋₁₂;
Y is a linking group and is present when X is other than a bond;
Ar is an arylene group which may be substituted by one or more groups selected from lalkyl, alkoxy, acylamino, alkylthio;
Z is a precursor for an amino group such as nitro, azo or acylamino or is a precursor for an alkylamino group such as an acylalkylamino; and
n is either 1 or 2 except that when X is a bond, n=1.

Preferably the group X is a 2,4-triazinyl group

Preferably the group Y is —NH— or —NR′— where R′ is an alkyl group optionally substituted by a hydroxyl or alkoxy or a halo group.

Preferably Ar is a 1,3-phenylene or a 1,4-phenylene group which may be substituted as described above.

Preferably the group Z is azo, nitro or acylamino. Reduction of azo and nitroaryl groups to aminoacyl may be effected by use of reagents such as sodium hydrosulphite, sodium sulphide, stannous chloride, sodium dithionite or titanium (III) chloride. Acylamino derivatives that can be readily converted to the free amino parent compounds include acetanilides which are readily prepared. De-acylation takes place under alkaline conditions to which cellulose is stable.

With regard to the effect chemical that may be used to treat cellulose containing material according to the method of the invention, examples of cross-linking agents typically used in the treatment of cellulosic fibres for imparting crease resistance include N,N′,N″-tris(acryloyl-)hexahydro triazine, 4-(2,4-dichloro-s-triazin-6-ylamino)benzene sulphonic acid, 4-(2,4-dichloro-s-triazin-6-ylamino)phenyl-β-sulphatoethyl sulphone and 2,4-dichloro-6-hydroxy-s-triazine. A typical flame retardant used with cellulosic materials is O,O′-bis(chloroethyl)vinyl phosphonate.

Cyclodextrins (α-, β- and λ-cyclodextrins possessing a monochlorotriazinyl reactive group) can be used for the controlled release of fragrances and also as scavengers for low molecular weight malodorous materials.

Reactive dyes typically possess 1, 2, 3 or more reactive groups which may be selected from halotriazinyl (including chloro-triazinyl, dichlorotriazinyl, fluorotriazinyl, bis(chlorotriazinyl), bis(fluorotriazinyl)); halopyrimidinyl such as 2,4,5-trichloropyrimidinyl, 2,4-dichloropyrimidinyl, 2,4-difluoro-5-chloropyrimidinyl, 2,4-difluoropyrimidinyl; vinyl sulphone or a precursor such as 2-sulphatoethyl sulphone, chloroethyl sulphone or 2-quaternary ammonium sulphone such as 2-(3-carboxypyridinium)ethyl sulphone and bromoacrylamide etc. Preferred dyes for use in the process of this invention are the halotriazinyl and vinyl sulphone-based reactive dyes but suitable dyes for the purpose include even low reactivity monochlorotriazinyl dyes which are however sufficiently reactive to effect essentially quantitative fixation with the modified (aminoarylated) cellulosic materials.

Typically reaction with the effect chemical will take place at pH 4 to 5 under which pH conditions undesired hydrolysis of the reactive groups of the dyes or other effect chemicals will be essentially suppressed, and fixation onto cellulose favoured. Advantageously, in the case of dyeing with a reactive dye, an electrolyte such as common salt is used. However, because fixation of the dye is effectively quantitative, rigorous washing off of the dyed material is not required, only a short rinse to remove excess electrolyte. The dyed fibre (or fabric) is rinsed with cold water to give good wet fastness. Advantageously also the dyebath, including dissolved electrolyte, is recycled.

The invention further provides novel chemically treated aminoaryl-substituted cellulosic materials having the formula:

Cell-O—X—(Y—Ar—NR-E)ₙ (IV)

wherein Cell-O, X, Y, Ar, R and n are as previously defined and where E is the molecular fragment of an effect chemical such as a dye, flame retardant or cyclodextrin. Also provided are materials of the formula:

(Cell-O—X—Y—Ar—NR)p-CL (V)

wherein Cell-O, X, Y, Ar and R are as previously defined, p is 2 or more and where CL is the molecular fragment of a cross linking agent.

The invention will now be further described with reference to the following examples.

### EXAMPLE 1

### Amination of cotton with 2-(3-carboxypyridinium)-4,6-bis([3-acetylamino-]phenylamino-)triazine

### 1. Synthesis of 2-(3-carboxypyridinium)-4,6-bis([3-acetylamino-]phenylamino-)triazine

This was prepared by a 2-stage synthesis depicted below:

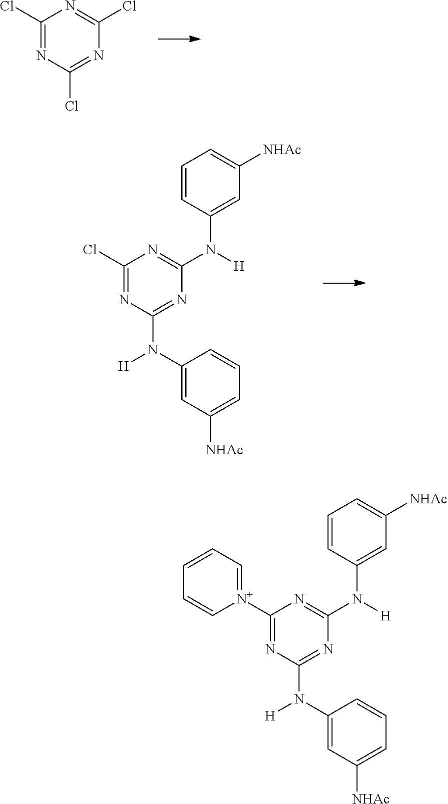

### (a) 2-Chloro-4,6-bis([3-acetylamino]phenylamino-)triazine

Sodium bicarbonate (16.8 g., 0.2 m) was added to a stirred solution of 3-amino acetanilide (31 g. 0.2 m), followed by a freshly prepared solution of 2,4,6-trichlorotriazine (18.5 g., 0.1 m) in acetone (100 ml). After heating to reflux for 2 hours further 3-aminoacetanilide (4.5 g) was added and heating was continued for a further 1 hour. The mixture was allowed to stand at room temperature overnight and solid was collected. This was stirred with cold water and residual solid was collected and dried. Yield 39.5 g., 96%.

### (b) 2-(3-carboxypyridinium)-4,6-bis([3-acetylamino-]phenylamino-)triazine

Pyridine (5.9 g., 0.075 m) was added to a freshly prepared solution of 2-chloro-4,6-bis([3-acetylamino-]phenylamino-)triazine (12.4 g., 0.03 m) in N-methylpyrrolidone (80 ml). The mixture was stirred at 60° C. for 8 hr. The mixture was allowed to cool to room temperature and acetone (80 ml) was added with stirring. The resulting solid was collected and dried. Yield 14.9 g.

### 2. Application of 2-(3-carboxypyridinium)-4,6-bis([3-acetylamino-]phenylamino-) triazine to cotton

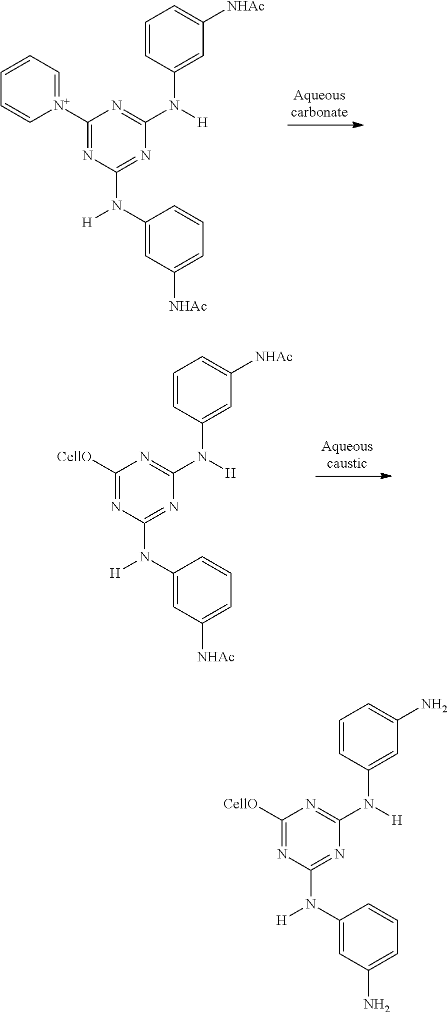

A 10 g piece of cotton was added to a solution of 2-(3-carboxypyridinium)-4,6-bis([3-acetylamino-]phenylamino-)triazine (0.8 g. in 40 ml of water) in brine (27.5 ml at 55 gpl) and water (22.5 ml) on a Roaches Wash Wheel at 30° C. for 60 min. Soda ash solution (10 ml at 20 gpl) was added and the machine run for a further 60 min at 30° C.

The resulting piece of treated cotton was immersed in aqueous sodium hydroxide (2N. 200 ml) at 80° C. for 2 hour.

Two pieces of the above treated cotton (1.15 g each) were treated separately with Procion Navy H-ER (0.5% and 1% omf) in presence of salt (0.92 g) and pH 5 buffer (total volume 11.5 ml). The mixtures were heated to 80° C. for 1 hr. The resulting dyed pieces of fabric were washed (boiling water, 15 min) to yield good dull blue dyeings.

### EXAMPLE 2

### Amination of cotton with 2-chloro-4,6-bis(4′-[4-sulphophenylazo-]phenylamino-)triazine

Knitted cotton fabric (100 g.) to which had been fixed 2-chloro-4,6-bis(4-[4-sulphophenylazo-]phenylamino-)triazine (40 g/kg,) was treated with a solution of titanium(III) chloride, in presence of potassium tartrate, at 100° C., to yield cotton with pendant 4,6-bis(4-aminophenylamino-)triazin-2-yloxy groups (56 mmole/kg) attached via the 6-hydroxy oxygen atoms of the cellulose.

A piece of the resulting modified cotton fabric (5 g.) was stirred in aqueous buffer (pH 4, 20 ml). A solution of Procion Navy H-ER (a bis(monochlorotriazinyl) reactive dye (0.05 g., 0.1% on mass of fibre(omf)) in water (80 ml) was added, followed by the slow addition of salt (8 g). The mixture was heated to 80° C. and held at this temperature for 120 min. On cooling the dyebath was clear and there was essentially no loose dye on the surface of the fabric, indicating complete fixation of dye to modified cotton.

Repeat experiments using 0.1 g. and 0.2 g of Procion Navy H-ER also showed complete fixation of dye. The optical strengths of the resulting dyeings are summarised in Table 1.

TABLE 1

| % Dye omf | 1 | 2 | 4 |
|---|---|---|---|
| % Fixation | 100 | 100 | 100 |
| K/S (at λ 610 nm) | 9.0 | 17.2 | 27.2 |

In control experiments using unmodified cotton the fixation efficiency of dye to cotton, under similar fixation conditions, was less than 5%, essentially all of the dye was removed during a wash process.

### EXAMPLE 3

### Amination of cotton with the quaternary salt derived from 2-chloro-4,6-bis([3-acetylamino-]phenylamino-)triazine and 1,4-diazabicyclo[2,2,2]octane

### 1. Synthesis of Quaternary Salt

This was prepared by a process similar to that described in Example 1:

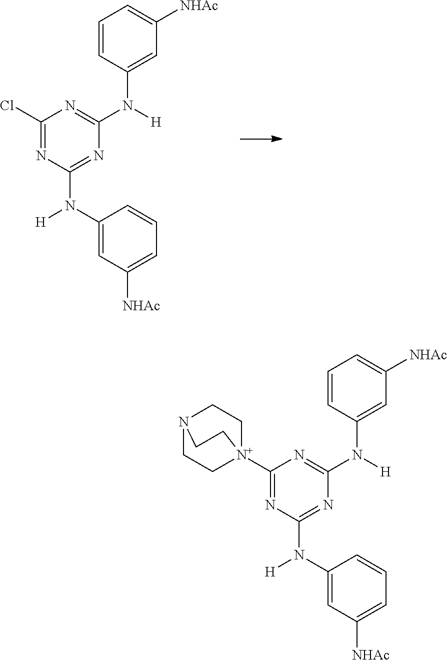

1,4-Diazabicyclo[2,2,2]octane (DABCO, 2.24 g) was added to a stirred solution of 2-chloro-4,6-bis([3-acetylamino-]phenylamino-)triazine (8.23 g) in N-methylpyrrolidone (50 ml). The mixture was stirred for 30 min. at 20° C., acetone (50 ml) was added and the resulting colourless solid was collected and dried (10.4 g).

### 2. Application of Above DABCO Quaternary Salt to Cotton

A 10 g piece of cotton was added to a solution of the above DABCO quaternary salt (0.8 g. in 40 ml of water) in brine (27.5 ml at 55 gpl) and water (22.5 ml) on a Roaches Wash Wheel at 30° C. for 60 min. Soda ash solution (10 ml at 20 gpl) was added and the machine run for a further 60 min at 30° C. followed by a further 60 min at 40° C.

The resulting piece of treated cotton was immersed in aqueous sodium hydroxide (2N, 200 ml) at 80° C. for 2 hour.

Two pieces of the above treated cotton (1 g each) were treated separately with Procion Navy H-ER (0.5% and 1% omf) in presence of salt, at pH 5 (total volume 10 ml). The mixtures were heated to 80° C. for 2 hr. The resulting dyed pieces of fabric were washed (boiling water, 15 min) to yield good dull blue dyeings.

1. An aminoarylated cellulosic material having the formula:
Cell-O—X—(Y—Ar—NHR)ₙ (I)
where Cell-O— represents a substituted hydroxyl of a cellulosic material;
X is a bond or a group selected from the following:
2,4-triazinyl optionally substituted in the 6-position by a group selected from alkoxy, alkylthio, amino, alkylamino (optionally substituted), dialkylamino (optionally substituted), arylamino (optionally substituted) and alkylarylamino (optionally substituted); 2,4-pyrimidinyl or 2,6-pyrimidinyl, the pyrimidine nucleus optionally carrying substituents selected from chloro and fluoro; alkylene C₁₋₆; and alkoxy C₂₋₁₂;
Y is a linking group and is present when X is other than a bond;
Ar is an arylene group which may be substituted by one or more groups selected from alkyl, alkoxy, acylamino, alkylthio;
R is H or an alkyl group which may by be substituted by a group selected from hydroxyl or alkoxy; and
n is either 1 or 2 except that when X is a bond, n=1.

2. An aminoarylated cellulosic material according to claim 1 wherein the group X is a 2,4-triazinyl group.

3. An aminoarylated cellulosic material according to claim 1 wherein the group Y is —NH— or —NR′ where R′ is alkyl optionally substituted by hydroxyl, alkoxy or halo.

4. An aminoarylated cellulosic material according to claim 1 wherein Ar is a 1,3-phenylene or a 1,4-phenylene group which may be substituted by one or more groups selected from alkyl, alkoxy, acylamino and alkylthio.

5. An aminoarylated cellulosic material according to claim 1 or wherein the cellulosic material is cotton, Ramie, hemp or a reconstituted cellulosic fibre.

6. A method for preparing an aminoarylated cellulosic material by reacting a cellulosic material with a reagent having the formula:
LG-X—(Y—Ar—Z)ₙ (II)
where LG is a leaving group selected from halo or a tertiary amine;
X is a bond or a group selected from the following:
2,4-triazinyl optionally substituted in the 6-position by a group selected from chloro, fluoro, alkoxy, alkylthio, amino, alkylamino (optionally substituted), dialkylamino (optionally substituted), arylamino (optionally substituted) and alkylarylamino (optionally substituted); 2,4-pyrimidinyl or 2,6-pyrimidinyl, the pyrimidine nucleus optionally carrying substituents selected from chloro and fluoro; alkylene C₁₋₆; and alkoxy C₂₋₁₂;
Y is a linking group and is present when X is other than a bond;
Ar is an arylene group which may be substituted by one or more groups selected from alkyl, alkoxy, acylamino, alkylthio;
Z is a precursor for an amino group selected from nitro or acylamino or is a precursor for an alkylamino group; and
n is either 1 or 2 except that when X is a bond, n=1
other than that where X is 2,4-triazinyl substituted in the 6-position by chloro, Y is —NH—, Ar is unsubstituted, Z is nitro and n=1, LG shall not be chloro;
and subsequently converting the group Z to an amino group.

7. A method as claimed in claim 6 in which the group X is a 2,4-triazinyl group.

8. A method as claimed in claim 6 in which the group Y is —NH— or —NR′ where R′ is alkyl optionally substituted by hydroxyl, alkoxy or halo.

9. A method as claimed in claim 6 in which the group Z is an acylalkylamino group.

10. A method as claimed in claim 6 in which Ar is a 1,3-phenylene or a 1,4-phenylene group which may be substituted by one or more groups selected from alkyl, alkoxy, acylamino and alkylthio.

11. A method as claimed in claim 6 in which the leaving group (LG) is fluorine or chlorine.

12. A method as claimed in claim 6 in which the leaving group is a heteroaryl tertiary amine.

13. A method as claimed in claim 12 wherein the leaving group is pyridine or a substituted pyridine.

14. A method as claimed in claim 6 wherein the leaving group is a non-hindered tertiary aliphatic amine such as diazabicyclo octane.

15. A method for reacting a cellulose-containing material with an effect chemical comprising the steps of:
a) effecting aminoarylation of the cellulose-containing material; and
b) applying to the product of step (a) an effect chemical under acidic conditions.

16. A method as claimed in claim 15 wherein step (a) comprises the method of claim 6.

17. A method as claimed in claim 15 wherein the product of Step (a) is an aminoarylated cellulosic material according to any one of claims 1 to 5.

18. A method according to claim 15 wherein the effect chemical is a reactive dye.

19. A method according to claim 15 wherein the effect chemical is a flame retardant.

20. A method according to claim 15 wherein the effect chemical is a cyclodextrin.

21. A method according to claim 15 wherein the effect chemical is a cross linking reagent.

22. A method as claimed in claim 18 wherein the reactive dye is a halotriazinyl or vinyl sulphone-based reactive dye.

23. A method as claimed in claim 6 wherein the cellulosic material is cotton, Ramie, hemp or a reconstituted cellulosic fibre.

24. A method as claimed in claim 6 in which the cellulosic material comprises at least 80% by weight of cellulose.

25. A method as claimed in claim 24 in which the cellulosic material is blended with poly(alkylene terephthalate)ether and/or a polyamide.

26. A method as claimed in claim 22 wherein the cellulosic material comprises cotton.

27. An aminoaryl-substituted cellulosic material having the formula:
Cell-O—X—(Y—Ar—NR-E)n (IV)
wherein Cell-O, X, Y, Ar, R and n are as previously defined and where E is the molecular fragment of an effect chemical such as a dye, flame retardant or cyclodextrin.

28. A material according to claim 27 wherein the effect chemical is a reactive dye such as a halotriazinyl or vinyl sulphone-based reactive dye.

29. An aminoaryl-substituted cellulosic material having the formula:
(Cell-O—X—Y—Ar—NR)p-CL (V)
wherein Cell-O, X, Y, Ar and R are as previously defined, p is 2 or more and where CL is the molecular fragment of a cross linking agent.
